(19) United States
(12) Patent Application Publication
(10) Pub. No.: US 2020/0173887 A1
(43) Pub. Date: Jun. 4, 2020

(54) PROCESSING APPARATUS, PROCESSING METHOD, AND NON-TRANSITORY STORAGE MEDIUM

(71) Applicant: NEC Corporation, Minato-ku, Tokyo (JP)

(72) Inventors: Yasuharu ONISHI, Tokyo (JP); Yasuyuki FUKUTA, Tokyo (JP); Takashi KUDO, Tokyo (JP)

(73) Assignee: NEC Corporation, Minato-ku, Tokyo (JP)

(21) Appl. No.: 16/615,200

(22) PCT Filed: Jan. 10, 2018
(86) PCT No.: PCT/JP2018/000241

§ 371 Date: Nov. 20, 2019

(30) Foreign Application Priority Data
May 25, 2017 (JP) 2017-103546

(51) Int. Cl. G01M 99/00; G05B 23/02

(52) U.S. Cl. CPC G01M 99/005; G05B 23/0259; G05B 23/0218

(57) ABSTRACT

The present invention provides a processing apparatus (10) including a first determination unit (11) that determines whether a target apparatus is normal or abnormal on the basis of detection data of a first sensor, and a second determination unit (12) that, in a case where the determination of normal or abnormal is impossible based on the detection data of the first sensor, starts a second sensor and determines whether the target apparatus is normal or abnormal on the basis of detection data of the second sensor.

### TECHNICAL FIELD

The present invention relates to a processing apparatus, a processing method, and a program.

### BACKGROUND ART

Patent Document 1 discloses an apparatus that, based on vibration sound transmitted to a member constituting a transmission line facility, detects an abnormality of the facility.

### RELATED DOCUMENT

### Patent Document

[Patent Document 1] Japanese Patent Application Publication No. 2011-193567

### SUMMARY OF THE INVENTION

### Technical Problem

When determination regarding whether a target apparatus is normal or abnormal, it is desirable to perform multilateral evaluation using a plurality of kinds of data. However, in a case where a plurality of kinds of data are measured using a plurality of sensors, power consumption increases. An object of the invention is to achieve power saving in a technique for determining whether a target apparatus is normal or abnormal using a plurality of kinds of data.

### Solution to Problem

The present invention provides a processing apparatus including a first determination unit that determines whether a target apparatus is normal or abnormal on the basis of detection data of a first sensor, and a second determination unit that, in a case where the determination of normal or abnormal is impossible based on the detection data of the first sensor, starts a second sensor and determines whether the target apparatus is normal or abnormal on the basis of detection data of the second sensor.

The present invention also provides a processing method executed by a computer, the method including a first determination step of determining whether a target apparatus is normal or abnormal on the basis of detection data of a first sensor, and a second determination step of, in a case where the determination of normal or abnormal is impossible based on the detection data of the first sensor, starting a second sensor and determining whether the target apparatus is normal or abnormal on the basis of detection data of the second sensor.

The present invention also provides a program causing a computer to function as a first determination unit that determines whether a target apparatus is normal or abnormal on the basis of detection data of a first sensor, and a second determination unit that, in a case where the determination of normal or abnormal is impossible based on the detection data of the first sensor, starts a second sensor and determines whether the target apparatus is normal or abnormal on the basis of detection data of the second sensor.

### Advantageous Effects of Invention

According to the invention, power saving is achieved in a technique for determining whether a target apparatus is normal or abnormal using a plurality of kinds of data.

### BRIEF DESCRIPTION OF THE DRAWINGS

The above and other objects, features, and advantages will be apparent from preferred example embodiments described below and the following accompanying drawings.

FIG. 1 is an example of a functional block diagram of a processing system of an example embodiment.

FIG. 2 is a diagram illustrating an example of the hardware configuration of the processing apparatus of the example embodiment.

FIG. 3 is an example of a functional block diagram of a processing apparatus of the example embodiment.

FIG. 4 is a flowchart illustrating an example of a processing flow of the processing apparatus of the example embodiment.

FIG. 5 is an example of a functional block diagram of the processing apparatus of the example embodiment.

FIG. 6 is a flowchart illustrating an example of a processing flow of the processing apparatus of the example embodiment.

FIG. 7 is an example of a functional block diagram of the processing apparatus of the example embodiment.

FIG. 8 is an example of a functional block diagram of the processing system of the example embodiment.

### DESCRIPTION OF EMBODIMENTS

### First Example Embodiment

First, the overall image and outline of a processing system of the example embodiment will be described. The processing system of the example embodiment is a system that determines whether a target apparatus is normal or abnormal. The processing system of the example embodiment is suitable for evaluation of a machining apparatus, such as a polishing machine or a cutting machine. Note that the processing system of the example embodiment may be applied to evaluation of other apparatuses.

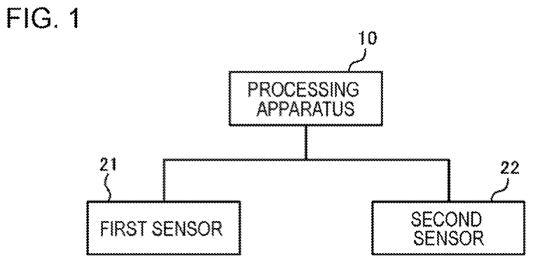

As illustrated in a functional block diagram of FIG. 1, the processing system of the example embodiment has a processing apparatus 10, one or a plurality of first sensors 21, and one or a plurality of second sensors 22. The processing apparatus 10, the first sensor 21, and the second sensor 22 are configured to perform communication by any communication unit. For example, the processing apparatus 10, the first sensor 21, and the second sensor 22 may be connected to one another by dedicated lines (wires) and perform communication, may perform communication with one another through short-distance wireless communication, or may be connected to one another by a local area network (LAN) and perform communication.

The first sensor 21 and the second sensor 22 are sensors that detect data related to the target apparatus. The first sensor 21 and the second sensor 22 are provided at positions where predetermined data related to the target apparatus can be detected.

The processing apparatus 10 is an apparatus that determines whether the target apparatus is normal or abnormal on the basis of detection data of the first sensor 21 and the second sensor 22. The processing apparatus 10 is provided in a field where the target apparatus is provided.

The first sensor 21 continuously operates and continues to detect data. In contrast, the second sensor 22 starts in a case where a predetermined condition is satisfied, and detects data only for a given time after the start. Specifically, the second sensor 22 starts in a case where the determination regarding whether the target apparatus is normal or abnormal is impossible based on the detection data of the first sensor 21, and detects data only for a given time after the start.

With the processing system of the example embodiment, it is possible to determine whether the target apparatus is normal or abnormal using a plurality of kinds of data acquired by a plurality of sensors. Therefore, it is possible to multilaterally evaluate a state of the target apparatus, and to increase reliability of a determination result regarding whether the target apparatus is normal or abnormal.

With the processing system of the example embodiment, instead of continuously operating all of the sensors, only a part (first sensor 21) can be operated and another part (second sensor 22) can be temporarily operated only in a case where a predetermined condition is satisfied. Therefore, it is possible to reduce power consumption compared to a case where all of the sensors are continuously operated.

With the processing system of the example embodiment, a condition for starting the second sensor 22 can be “a case where the determination regarding whether the target apparatus is normal or abnormal is impossible based on the detection data of the first sensor 21”.

In a case where the determination regarding whether the target apparatus is normal or abnormal is possible based on the detection data of the first sensor 21, a determination result thereof may be employed, and it is not necessary to perform further determination based on other kinds of data. On the other hand, in a case where the determination regarding whether the target apparatus is normal or abnormal is impossible based on the detection data of the first sensor 21, determination is performed from other viewpoints based on other kinds of data, thereby attempting determination regarding whether the target apparatus is normal or abnormal. In this way, since the second sensor 22 is operated only where necessary, and the operation of the second sensor 22 at an unnecessary timing can be suppressed, it is possible to efficiently achieve reduction in power consumption.

Next, the configuration of the processing apparatus 10 will be described in detail. First, an example of the hardware configuration of the processing apparatus 10 will be described. Functional units included in the processing apparatus 10 of the example embodiment are implemented by any combination of hardware and software centering on a central processing unit (CPU), a memory, a program loaded on the memory, a storage unit (capable of storing programs stored in advance at the time of shipment of the apparatus as well as programs downloaded from a storage medium, such as a compact disc (CD), or a server on the Internet), such as a hard disk that stores the program, and an interface for communication network connection of any computer. In addition, those skilled in the art can understand that that various modification examples can be made to the implementation method and the apparatus.

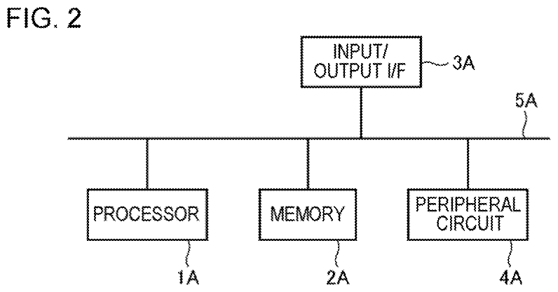

FIG. 2 is a block diagram illustrating the hardware configuration of the processing apparatus 10 of the example embodiment. As illustrated in FIG. 2, the processing apparatus 10 has a processor 1A, a memory 2A, an input/output interface 3A, a peripheral circuit 4A, and a bus 5A. In the peripheral circuit 4A, various modules are included.

The bus 5A is a data transmission line through which the processor 1A, the memory 2A, the peripheral circuit 4A, and the input/output interface 3A transmit and receive data to and from one another. The processor 1A is, for example, an arithmetic processing apparatus, such as a CPU or a graphics processing unit (GPU). The memory 2A is, for example, a memory, such as a random access memory (RAM) or a read only memory (ROM). The input/output interface 3A includes an interface for acquiring information from an input apparatus (example: a keyboard, a mouse, a microphone, a physical key, a touch panel display, a code reader, and the like), an external apparatus, an external server, an external sensor, and the like and an interface for outputting information to an output apparatus (example: a display, a speaker, a printer, a mailer, and the like), the external apparatus, the external server, and the like. The processor 1A can give a command to each module and can perform an arithmetic operation based on an arithmetic result of the module.

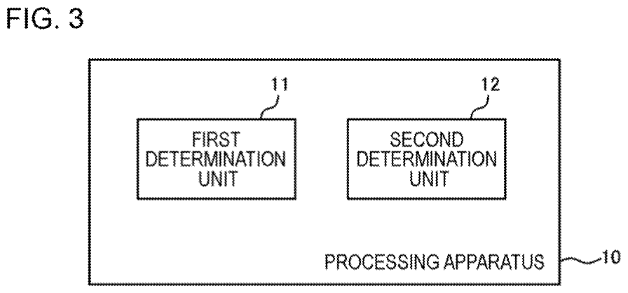

Next, the functional configuration of the processing apparatus 10 will be described. FIG. 3 illustrates an example of a functional block diagram of the processing apparatus 10. As illustrated in the drawing, the processing apparatus 10 includes a first determination unit 11 and a second determination unit 12.

The first determination unit 11 determines whether the target apparatus is normal or abnormal on the basis of detection data (example: time-series data of detection values) of the first sensor 21. The first sensor 21 continuously operates and continues to detect data. Then, the first determination unit 11 continues determination based on data detected by the first sensor 21.

The first determination unit it can perform the above-described determination, for example, using an estimation model obtained by machine learning based on training data with an explanatory variable and a criterion variable (normal or abnormal) in pair. A determination result in this case becomes any one of “normal”, “abnormal”, or “unclear (determination of normal or abnormal is impossible)”. In a case where learned training data is not sufficient, the determination result is likely to be “unclear”.

An estimation technique is a matter of design, and all sorts of techniques can be employed. The explanatory variable may be time-series data of detection values detected by the first sensor 21 or may be a feature value extracted from the time-series data. The kind of feature value is a matter of design. The explanatory variable may include an environment of the target apparatus, a machining condition of a product being processed by the target apparatus, and the like. In regard to the environment of the target apparatus, a temperature, humidity, or the like of a position where the target apparatus is provided is exemplified; however, the invention is not limited thereto. In regard to the machining condition of the product, the settings of the target apparatus, the kinds of accessories (example, a polishing liquid and the like) for use in machining the product, and the like are exemplified; however, the invention is not limited thereto.

In determination using the detection data of the first sensor 21 and the estimation model, the first determination unit 11 may input the detection data of the first sensor 21 (time-series data of detection values for a predetermined time) or a feature value extracted from the detection data of the first sensor 21 to the estimation model without preprocessing thereon to perform determination. Then, the first determination unit 11 may output a determination result thereof.

Alternatively, the first determination unit 11 may perform one kind or a plurality of kinds of preprocessing on the detection data of the first sensor 21 and may input detection data after the preprocessing or a feature value extracted from the detection data to the estimation model to perform determination. Then, the first determination unit 11 may output a determination result thereof.

Alternatively, the first determination unit 11 may combine the above-described methods. That is, the first determination unit 11 may first input the detection data of the first sensor 21 or the feature value extracted from the detection data of the first sensor 21 to the estimation model without preprocessing thereon to perform determination. Then, in a case where a determination result is “normal” or “abnormal”, the first determination unit 11 may output the determination result.

On the other hand, in a case where the determination result is “unclear”, the first determination unit 11 may perform one kind or a plurality of kinds of preprocessing on the detection data of the first sensor 21 and may input detection data after the preprocessing or a feature value extracted from the detection data to the estimation model to perform determination again. Then, the first determination unit 11 may output a determination result thereof.

Note that, in a case where the above-described methods are combined, the kinds of preprocessing to be executed may be increased in a stepwise manner. That is, in a case where the determination result with the input of the detection data of the first sensor 21 or the feature value extracted from the detection data of the first sensor 21 to the estimation model without preprocessing thereon is “unclear”, the first determination unit 11 may input the detection data subjected to first preprocessing or a feature value extracted from the detection data to the estimation model to perform determination again. Then, in a case where the determination result is “normal” or “abnormal”, the first determination unit 11 may output the determination result.

On the other hand, in a case where the determination result is “unclear”, the first determination unit 11 may input detection data subjected to the first preprocessing and second preprocessing or a feature value extracted from the detection data to the estimation model to perform determination again. In this way, while the determination result “unclear” is kept, the kinds of preprocessing to be executed may be increased in a stepwise manner. Then, in a case where the determination result is “unclear” even though all kinds of preprocessing are executed, the first determination unit 11 may output the determination result.

The preprocessing includes at least one of level correction (correction of a base line), noise processing (unnecessary peak elimination), and narrowing-down of processing data (zooming-in of a waveform). Note that the preprocessing may include other kinds of processing. Hereinafter, each kind of processing will be described.

“Level Correction”

A base line of detection data is corrected, thereby correcting a level of a peak included in the detection data. The first determination unit 11 may perform the correction of the base line based on the environment of the target apparatus, the machining condition of the product being processed by the target apparatus, or the like, and a rule determined in advance.

“Noise Processing”

In noise processing, a peak (noise) not related to the target apparatus is eliminated. For example, the first determination unit 11 acquires detection data from a plurality of different first sensor 21 (same characteristics and same settings) at different distances from the target apparatus and synchronizes the detection data acquired from a plurality of first sensors 21. Then, the first determination unit 11 eliminates peaks of which the relationship with corresponding peaks (peaks based on the same factor included in the detection data of a plurality of first sensors 21) does not satisfy the predetermined condition as noise.

The predetermined condition is “the detection data of the first sensor 21 at a smaller distance from the target apparatus has a greater peak”. This is based on that the distance of the first sensor 21 at a closer to the target apparatus is more likely to detect data (example: vibration, sound, or the like) due to the target apparatus.

“Narrowing-down of Processing Data”

Data as a processing target (a target of processing for inputting to the estimation model or processing for extracting the feature value) is narrowed down. For example, a range of a frequency is narrowed down. With this, the difference between an upper limit and a lower limit of a peak level in data to be processed becomes small. In this state, the correction of the base line and the zooming-in of the waveform are performed in this state, whereby it is possible to improve the zooming-in efficiency of the waveform while keeping the difference between the upper limit and the lower limit of the peak level within a predetermined range.

In a case where the determination of normal or abnormal is impossible based on the detection data of the first sensor 21, that is, in a case where the determination result “unclear” is output from the first determination unit 11, the second determination unit 12 starts the second sensor 22. Then, the second determination unit 12 determines whether the target apparatus is normal or abnormal on the basis of the detection data of the second sensor 22.

The second sensor 22 detects data of a kind different from the first sensor 21. Note that the first sensor 21 may have power consumption smaller than the second sensor 22. That is, a sensor having relatively small power consumption may be used as the first sensor 21 that is continuously operated, and a sensor having relatively large power consumption may be used as the second sensor 22 that is started according to a predetermined condition.

Hereinafter, specific examples of the first sensor 21 and the second sensor 22 will be described.

### Example 1

In Example 1, the first sensor 21 and the second sensor 22 detect the same kind of data, specifically, vibration or sound. Then, the second sensor 22 has a bandwidth to be detected narrower than the first sensor 21.

The first sensor 21 may have a comparatively broad bandwidth (example: 10 Hz to 20 kHz) as the bandwidth to be detected, and the second sensor 22 may have a part (example: 10 Hz to 1 kHz, 1 kHz to 5 kHz, 5 kHz to 20 kHz, or the like) included in the bandwidth of the first sensor 21 as the bandwidth to be detected. The second sensor 22 having a narrow bandwidth can collect data with higher sensitivity.

In this case, the bandwidth of the first sensor 21 may be covered with a plurality of second sensors 22. That is, in a case where the bandwidth of the first sensor 21 is 10 Hz to 20 kHz, the bandwidth of one second sensor 22 may be set to 10 Hz to 1 kHz, the bandwidth of another second sensor 22 may be set to 1 kHz to 5 kHz, and the bandwidth of another second sensor 22 may be set to 5 kHz to 20 kHz.

A band to be detected of the first determination unit 11 and a band to be detected of the second sensor 22 can be decided according to the specification, setting, or the like of the target apparatus.

### Example 2

In Example 2, the first sensor 21 detects vibration or sound. Then, the second sensor 22 detects data other than vibration or sound. That is, the first sensor 21 and the second sensor 22 detect different kinds of data.

For example, the first sensor 21 may detect vibration, and the second sensor 22 may detect sound. Alternatively, the first sensor 21 may detect sound, and the second sensor 22 may detect vibration. Alternatively, the first sensor 21 may detect vibration or sound, and the second sensor 22 may detect at least one of a temperature, pressure, a rotation speed of a polishing machine, a flow rate of a polishing liquid, and a PH of the polishing liquid. The second sensor 22 may capture an image (still image or moving image) of a predetermined part of the target apparatus. Note that a plurality of kinds of data may be detected by a plurality of second sensors 22.

The second determination unit 12 can perform the above-described determination using an estimation model obtained by machine learning. Details are the same as the determination in the first determination unit 11. A determination result in this case becomes any one of “normal”, “abnormal”, and “unclear (determination of normal or abnormal is impossible)”. In a case where learned training data is not sufficient, the determination result is likely to be “unclear”.

In the determination using the detection data of the second sensor 22 and the estimation model, the second determination unit 12 may input the detection data of the second sensor 22 (time series data of detection values for a predetermined time or a feature value extracted from the time-series data) to the estimation model without preprocessing thereon to perform determination. Then, the second determination unit 12 may output a determination result thereof.

Alternatively, the second determination unit 12 may execute one kind or a plurality of kinds of preprocessing on the detection data of the second sensor 22 and may input the detection data after the preprocessing or a feature value extracted from the detection data to the estimation model to perform determination. Then, the second determination unit 12 may output a determination result thereof.

Alternatively, the second determination unit 12 may combine the above-described methods. That is, the second determination unit 12 may first input the detection data of the second sensor 22 or the feature value extracted from the detection data to the estimation model without preprocessing thereon to perform determination. Then, in a case where the determination result is “normal” or “abnormal”, the second determination unit 12 may output the determination result.

On the other hand, in a case where the determination result is “unclear”, the second determination unit 12 may input the detection data subjected to one kind or a plurality of kinds of preprocessing or the feature value extracted from the detection data to the estimation model to perform determination again. Then, the second determination unit 12 may output a determination result thereof.

Note that, in a case where the above-described methods are combined, the kinds of preprocessing to be executed may be increased in a stepwise manner. That is, in a case where the determination result with the input of the detection data of the second sensor 22 or the feature value extracted from the detection data to the estimation model without preprocessing thereon is “unclear”, the second determination unit 12 may input detection data subjected to first preprocessing or a feature value extracted from the detection data to the estimation model to perform determination again. Then, in a case where the determination result is “normal” or “abnormal”, the second determination unit 12 may output the determination result.

On the other hand, in a case where the determination result is “unclear”, the second determination unit 12 may input detection data subjected to the first preprocessing and second preprocessing or a feature value extracted from the detection data to the estimation model to perform determination again. In this way, while the determination result “unclear” is kept, the kinds of preprocessing to be executed may be increased in a stepwise manner. Then, in a case where the determination result is “unclear” even though all kinds of preprocessing are executed, the second determination unit 12 may output the determination result.

Details of the preprocessing are the same as the preprocessing executed by the first determination unit 11.

The second determination unit 12 may start a plurality of second sensors 22 in a stepwise manner. That is, in a case where the determination of normal or abnormal is impossible based on the detection data of the first sensor 21, the second determination unit 12 may start a second-1 sensor 22 that is a part of a plurality of second sensors 22. In a case where a determination result based on detection data of the second-1 sensor 22 is “normal” or “abnormal”, the second determination unit 12 may output the determination result.

On the other hand, in a case where the determination result based on the detection data of the second-1 sensor 22 is “unclear”, the second determination unit 12 may start a second-2 sensor 22 that is another part of a plurality of second sensors 22. In this case, the second-1 sensor 22 may be stopped. Then, in a case where the determination result based on the detection data of the second-2 sensor 22 is “normal” or “abnormal”, the second determination unit 12 may output the determination result.

On the other hand, in a case where the determination result based on the detection data of the second-2 sensor 22 is “unclear”, the second determination unit 12 may start a second-3 sensor 22 that is another part of a plurality of second sensors 22. In this case, the second-2 sensor 22 may be stopped.

In this way, while the determination result “unclear” is kept, the second sensors 22 to be executed may be switched sequentially. Then, in a case where the determination result is “unclear” even though all of the second sensors 22 are started, the second determination unit 12 may output the determination result.

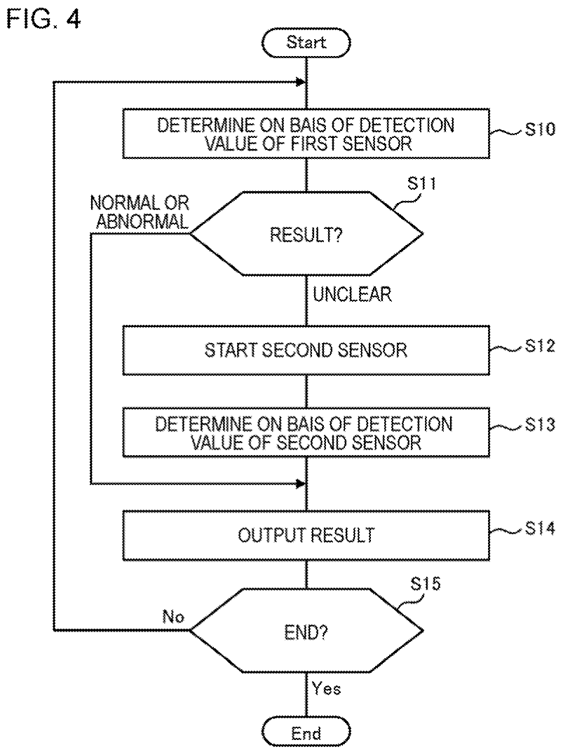

Next, an example of a processing flow of the processing apparatus 10 of the example embodiment will be described referring to a flowchart of FIG. 4.

In a case where the processing starts, the first determination unit 11 starts determination regarding whether the target apparatus is normal or abnormal based on the detection data of the first sensor 21 (S10). That is, the first determination unit 11 starts the first sensor 21 and causes the first sensor 21 to start to detect data. Then, the first determination unit 11 acquires the detection data from the first sensor 21 and performs the above-described determination.

In a case where the determination result output from the first determination unit 11 is “normal” or “abnormal” (S11), the processing apparatus 10 outputs the determination result (S14). The processing apparatus 10 can output the determination result through all sorts of output apparatuses, such as a display, a speaker, a lamp, and a mailer.

On the other hand, in a case where the determination result output from the first determination unit 11 is “unclear” (S11), the second determination unit 12 starts the second sensor 22 and causes the second sensor 22 to detect data for a given time (example: a time determined in advance or until the determination result of the second determination unit 12 is output) after the start (S12). Then, the second determination unit 12 acquires the detection data from the second sensor 22 and determines whether the target apparatus is normal or abnormal on the basis of the detection data (S13). Note that, in a case where the detection of data for the above-described given time is completed, the operation of the second sensor 22 may stop the operation.

Thereafter, the processing apparatus 10 outputs the determination result of the second determination unit 12 (S14). The determination result to be output is “normal”, “abnormal”, or “unclear”. The processing apparatus 10 can output the determination result through all sorts of output apparatuses, such as a display a speaker, a lamp, and a mailer.

Subsequently, while there is no instruction input to end the processing (in S15. No), the processing apparatus 10 continues the processing.

Next, the advantageous effects of the processing system of the example embodiment will be described. With the processing system of the example embodiment, it is possible to determine whether the target apparatus is normal or abnormal using a plurality of kinds of data acquired by a plurality of sensors. Therefore, it is possible to multilaterally evaluate the state of the target apparatus, and to determine whether the target apparatus is normal or abnormal with high accuracy.

With the processing system of the example embodiment, instead of continuously operating all of the sensors, only a part (first sensor 21) can be continuously operated, and another part (second sensor 22) can be temporarily operated only in a case where the predetermined condition is satisfied. Therefore, it is possible to reduce power consumption compared to a case where all of the sensors are continuously operated.

With the processing system of the example embodiment, the condition for starting the second sensor 22 can be “a case where the determination regarding whether the target apparatus is normal or abnormal is impossible based on the detection data of the first sensor 21”.

In a case where the determination regarding whether the target apparatus is normal or abnormal is possible based on the detection data of the first sensor 21, a determination result thereof may be employed, and it is not necessary to perform further determination based on other kinds of data. On the other hand, in a case where the determination regarding whether the target apparatus is normal or abnormal is impossible based on the detection data of the first sensor 21, determination is performed from other viewpoints based on other kinds of data, thereby attempting determination regarding whether the target apparatus is normal or abnormal. In this way, since the second sensor 22 is operated only where necessary, and the operation of the second sensor 22 at an unnecessary timing can be suppressed, it is possible to efficiently achieve reduction in power consumption.

With the processing system of the example embodiment, it is possible to determine whether the target apparatus is normal or abnormal using the estimation model obtained by machine learning. In this case, machine learning with more training data makes it possible to avoid inconvenience that the determination result is “unclear”. In other words, in a case where learned training data is not sufficient, the determination result is highly likely to be “unclear”.

For example, as represented by manufacturing of an aero-engine, or the like, in manufacturing of one product, not mass manufacturing of standardized products, since the state of the product may be individually different, the state of target equipment that processes the product may be different according to the product to be processed. Therefore, it is difficult to prepare training data in advance so as to cover all sorts of situations, and to allow training data to be learned. As a result, the determination result is highly likely to be “unclear”.

In a case where the determination result is “unclear”, it is difficult for a person in a field hardly to make decision. In a case where an abnormality occurs, it is preferable to instantly stop the target equipment. On the other hand, in a case where the target equipment is stopped, a production line is stopped, and severe damage occurs. Therefore, it is preferable to avoid the stopping of the target equipment in a state of no abnormality as much as possible.

With the processing system of the example embodiment, in a case where the determination result is “unclear”, various kinds of preprocessing can be executed on the detection data and determination can be performed using the processed detection data again or different sensors can be started to detect different kinds of data and determination can be performed based on the detected data again. In this way, multilateral evaluation is performed, whereby it is possible to suppress inconvenience that the determination result to be output is “unclear”.

With the processing system of the example embodiment, a sensor having relatively small power consumption can be used as the first sensor 21 that is continuously operated, and a sensor having relatively large power consumption can be used as the second sensor 22 that is started according to a predetermined condition. With this configuration, it is possible to implement power saving.

### Second Example Embodiment

A processing system of the example embodiment is different from the first example embodiment in that the processing apparatus 10 has a function of controlling the target apparatus. Specifically, the processing apparatus 10 transmits a control signal for stopping the operation to the target apparatus in a case where the determination results of the first determination unit 11 and the second determination unit 12 satisfy predetermined conditions. Hereinafter, the configuration of the processing system of the example embodiment will be described in detail.

The hardware configuration of the processing apparatus 10 of the example embodiment is the same as that in the first example embodiment.

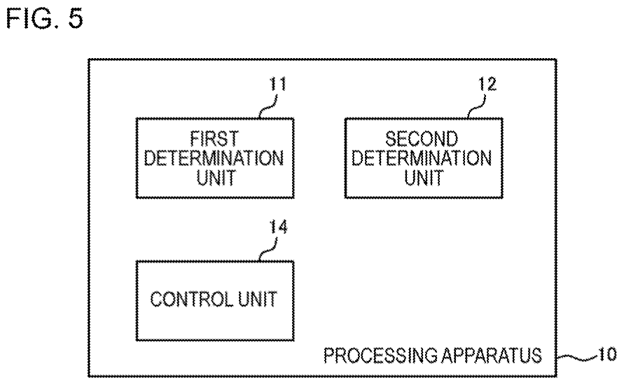

FIG. 5 illustrates an example of a functional block diagram of the processing apparatus 10 of the example embodiment. As illustrated in the drawing, the processing apparatus 10 has the first determination unit 11, the second determination unit 12, and the control unit 14. The configurations of the first determination unit 11 and the second determination unit 12 are the same as those in the first example embodiment. The configurations of the first sensor 21 and the second sensor 22 are the same as those in the first example embodiment.

The control unit 14 controls the operation of the target apparatus. Specifically, the control unit 14 transmits the control signal for stopping the operation to the target apparatus in a case where the determination results of the first determination unit 11 and the second determination unit 12 satisfy the predetermined conditions.

For example, in a case where the target apparatus is determined as abnormal on the basis of the detection data of the first sensor 21 or the detection data of the second sensor 22, that is, in a case where the determination result “abnormal” is output from the first determination unit 11 or the second determination unit 12, the control unit 14 can transmit control signal for stopping the operation to the target apparatus. In this case, the target apparatus may stop the operation of the own apparatus instantly in response to the reception of the control signal.

In a case where the determination of normal or abnormal is impossible based on the detection data of the second sensor 22, that is, in a case where the determination result “unclear” is output from the second determination unit 12, the control unit 14 can transmit the control signal for stopping the operation to the target apparatus. Note that this case is a case where the determination of normal or abnormal is impossible even based on the detection data of the first sensor 21. In this case, the target apparatus may stop the operation of the own apparatus instantly in response to the reception of the control signal. Alternatively, the target apparatus may stop the operation of the own apparatus after processing in execution at the time of the reception of the control signal is completed.

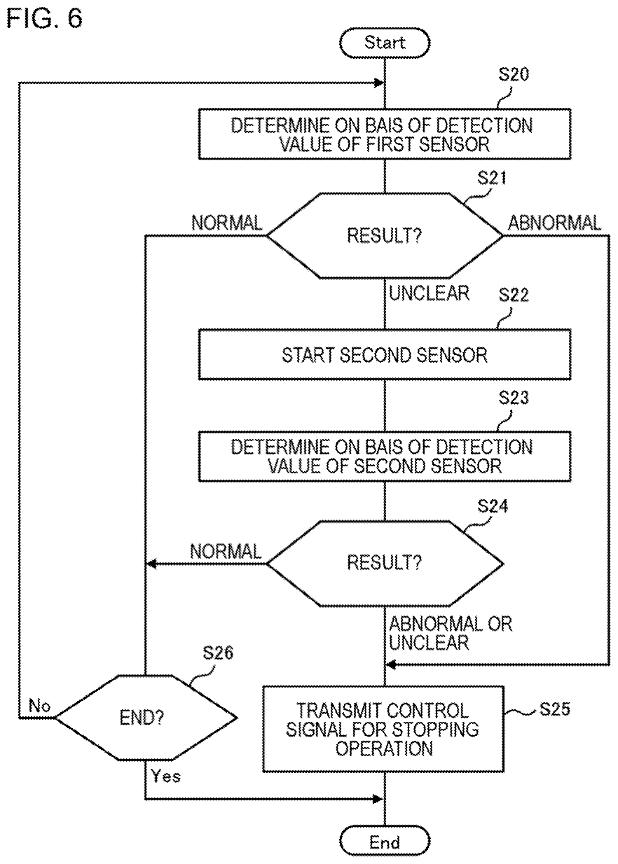

Next, an example of a processing flow of the processing apparatus 10 of the example embodiment will be described referring to a flowchart of FIG. 6.

In a case where the processing starts, the first determination unit 11 starts determination regarding whether the target apparatus is normal or abnormal based on the detection data of the first sensor 21 (S20). That is, the first determination unit 11 starts the first sensor 21 and causes the first sensor 21 to start to detect data. Then, the first determination unit 11 acquires the detection data from the first sensor 21 and performs the above-described determination.

In a case where the determination result output from the first determination unit 11 is “normal” (S21), and in a case where there is no instruction input to end the processing (in S26, No), the processing apparatus 10 returns to S20 and repeats the processing.

In a case where the determination result output from the first determination unit 11 is “abnormal” (S21), the control unit 14 transmits the control signal for stopping the operation to the target apparatus (S25). The target apparatus may stop the operation of the own apparatus instantly in response to the reception of the control signal.

In a case where the determination result output from the first determination unit 11 is “unclear” (S21), the second determination unit 12 starts the second sensor 22 and causes the second sensor 22 to detect data for a given time (example: a time determined in advance or until the determination result of the second determination unit 12 is output) after the start (S22). Then, the second determination unit 12 acquires the detection data from the second sensor 22 and determines whether the target apparatus is normal or abnormal on the basis of the detection data (S23). Note that, in a case where the detection of data for the above-described given time is completed, the operation of the second sensor 22 may stop the operation.

In a case where the determination result output from the second determination unit 11 is “normal” (S24), and in a case where there is no instruction input to end the processing (in S26, No), the processing apparatus 10 returns to S20 and repeats the processing.

In a case where the determination result output from the second determination unit 12 is “abnormal” or “unclear” (S24), the control unit 14 transmits the control signal for stopping the operation to the target apparatus (S25). In a case where the determination result is “abnormal”, the target apparatus may stop the operation of the own apparatus instantly in response to the reception of the control signal. On the other hand, in a case where the determination result is “unclear”, the target apparatus may stop the operation of the own apparatus instantly in response to the reception of the control signal or may stop the operation of the own apparatus after processing in execution at the time of the reception of the control signal is completed. In this case, the control signal transmitted from the control unit 14 may include information capable of identifying the determination result of the second determination unit 12.

Note that, after S21, the processing apparatus 10 may output the determination result of the first determination unit 11. The processing apparatus 10 can output the determination result through all sorts of output apparatuses, such as a display, a speaker, a lamp, and a mailer.

After S24, the processing apparatus 10 may output the determination result of the second determination unit 12. The processing apparatus 10 can output the determination result through all sorts of output apparatuses, such as a display, a speaker, a lamp, and a mailer.

Next, the advantageous effects of the processing system of the example embodiment will be described. With the processing system of the example embodiment, it is possible to achieve the same advantageous effects as the first example embodiment.

Furthermore, the processing apparatus 10 of the example embodiment can control the operation of the target apparatus. Therefore, in a case where an abnormality of the target apparatus is detected, the processing apparatus 10 can transmit the control signal for stopping the operation and can stop the operation of the target apparatus. As a result, it is possible to reduce inconvenience that the target apparatus continues to be operated in an abnormal state and damage becomes large.

In a case where the determination result is “unclear” even though determination is performed in both of the first determination unit 11 and the second determination unit 12, the processing apparatus 10 can transmit the control signal for stopping the operation and can stop the operation of the target apparatus. As a result, it is possible to reduce a risk that the target apparatus continues to be operated in an unclear state and damage becomes large.

### Third Example Embodiment

A processing system of the example embodiment is different from the first and second example embodiments in that a function of accumulating detection data with which the determination result is “unclear” is provided. For example, “normal” or “abnormal” is associated with accumulated detection data to form new training data. Hereinafter, the configuration of the processing system of the example embodiment will be described in detail.

The hardware configuration of the processing apparatus 10 of the example embodiment is the same as that in the first and second example embodiments.

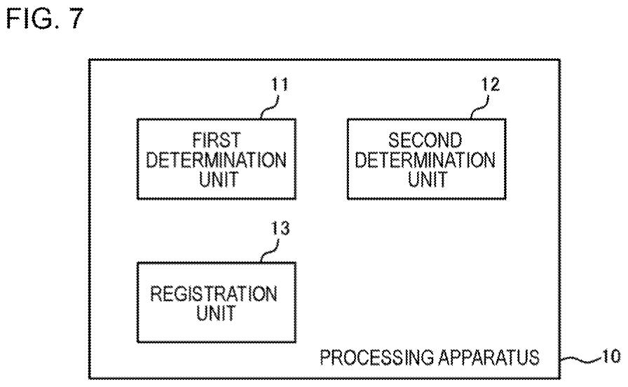

FIG. 7 illustrates an example of a functional block diagram of the processing apparatus 10 of the example embodiment. As illustrated in the drawing, the processing apparatus 10 has the first determination unit 11 the second determination unit 12, and the registration unit 13. Though not illustrated, the processing apparatus 10 may have the control unit 14. The configurations of the first determination unit 11, the second determination unit 12, and the control unit 14 are the same as those in the first and second example embodiments. The configurations of the first sensor 21 and the second sensor 22 are the same as those in the first and second example embodiments.

The registration unit 13 stores determination-impossible data in a storage unit. The determination-impossible data is detection data (time-series data of detection values for a predetermined time) with which determination of normal or abnormal is impossible in the detection data of the first sensor 21 and the detection data of the second sensor 22. That is, the determination-impossible data is detection data with which the determination result is “unclear”. The storage unit may be provided in the processing apparatus 10 or may be provided in an external apparatus configured to perform communication with the processing apparatus 10.

The registration unit 13 can store the determination-impossible data in the storage unit in association with various kinds of information.

For example, the registration unit 13 may store the determination-impossible data in the storage unit in association with date and time on which the determination-impossible data is detected.

Alternatively, the registration unit 13 may store the determination-impossible data in the storage unit in association with a machining condition of a product that is being processed by the target apparatus at the time when the determination-impossible data is detected. In regard to the machining condition of the product, the settings of the target apparatus, the kinds of accessories (example, a polishing liquid and the like) for use in machining the product, and the like are exemplified; however, the invention is not limited thereto.

Alternatively, the registration unit 13 may store the determination-impossible data in the storage unit in association with an environment of the target apparatus at the time when the determination-impossible data is detected. In regard to the environment of the target apparatus, a temperature, humidity, or the like of a position where the target apparatus is provided is exemplified; however, the invention is not limited thereto.

Alternatively, the registration unit 13 may store the determination-impossible data in the storage unit in association with identification information of the product that is being processed by the target apparatus at the time when the determination-impossible data is detected.

With the processing apparatus 10 of the example embodiment, it is possible to accumulate the determination-impossible data with which the determination result is “unclear”. The processing apparatus 10 may associate “normal” or “abnormal” with the determination-impossible data to form new training data. In this way, the performance of the estimation model for use in the determination of the first determination unit 11 and the second determination unit 12 is improved, and it is possible to decrease a frequency in which the determination result is “unclear”.

Here, means for associating “normal” or “abnormal” with the determination-impossible data will be described. For example, the processing apparatus 10 may receive a user input to specify “normal” or “abnormal” to each piece of determination-impossible data. In this case, the processing apparatus 10 may output, toward the user, information related to determination-impossible data of a target, to which “normal” or “abnormal” is specified, specifically, date and time on which the determination-impossible data is detected, the machining condition of the product that is being processed by the target apparatus at the time when the determination-impossible data is detected, the environment of the target apparatus at the time when the determination-impossible data is detected, the identification information of the product that is being processed by the target apparatus at the time when the determination-impossible data is detected, and the like. The output can be implemented through all sorts of output apparatuses, such as a display and a mailer.

The user can determine, on the basis of the above-described information, the state (normal or abnormal) of the target apparatus at the time when each piece of determination-impossible data is detected and can input the state to the processing apparatus 10.

In a case where the determination result of the second determination unit 12 is “normal” or “abnormal”, the processing apparatus 10 may associate the determination result with the determination-impossible data in the detection data of the first sensor 21, with which the determination of normal or abnormal is impossible.

Next, the advantageous effects of the processing system of the example embodiment will be described. With the processing system of the example embodiment, it is possible to achieve the same advantageous effects as the first and second example embodiments.

With the processing system of the example embodiment, it is possible to accumulate and effectively utilize the detection data (determination-impossible data) with which the determination result is “unclear”. For example, the determination-impossible data can be used as training data. With the processing system of the example embodiment, the more an experience of determination processing is accumulated, the more training data is enhanced and the reliability of the determination result is improved.

With the processing system of the example embodiment, the determination result (the determination result of the second determination unit 12) based on the detection data different from the first sensor 21 can be associated with the determination-impossible data in the detection data of the first sensor 21, with which the determination of normal or abnormal is impossible, to form training data. In such a case, it is possible to reduce a burden on the user in specifying “normal” or “abnormal” to the determination-impossible data.

### Modification Example

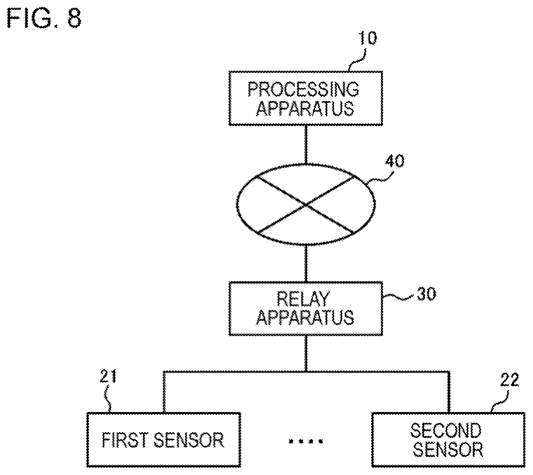

A modification example that can be applied to the first to third example embodiments will be described. FIG. 8 illustrates an example of a functional block diagram of a processing system of the modification example. The processing system of the modification example has the processing apparatus 10, the first sensor 21, the second sensor 22, and a relay apparatus 30.

The processing apparatus 10 of the modification example is a server (example: cloud server), and is provided at a place different from the field where the target apparatus is provided. The relay apparatus 30 is provided in the field where the target apparatus is provided.

The processing apparatus 10 and the relay apparatus 30 perform communication through a wide area communication network 40, such as the Internet. The first sensor 21 and the second sensor 22, and the relay apparatus 30 may be connected to each other by dedicated lines (wires) and perform communication, may perform communication with each other through short-distance wireless communication, or may be connected to each other by a local area network (LAN) and perform communication.

The relay apparatus 30 acquires the detection data from the first sensor 21 and the second sensor 22, and transmits the detection data to the processing apparatus 10. The relay apparatus 30 receives a signal for controlling the first sensor 21 and the second sensor 22 from the processing apparatus 10, and transmits the signal to the first sensor 21 and the second sensor 22. The relay apparatus 30 receives a signal for controlling the target apparatus from the processing apparatus 10, and transmits the signal to the target apparatus.

Even in the modification example, the same advantageous effects as in the first to third example embodiments are achieved.

Hereinafter, examples of reference embodiments will be added below.

1. A processing apparatus including

a first determination unit that determines whether a target apparatus is normal or abnormal on the basis of detection data of a first sensor, and

a second determination unit that, in a case where the determination of normal or abnormal is impossible based on the detection data of the first sensor, starts a second sensor and determines whether the target apparatus is normal or abnormal on the basis of detection data of the second sensor.

2. The processing apparatus according to 1, further including

a registration unit that stores, in a storage unit, determination-impossible data, which is the detection data of the first sensor and the detection data of the second sensor with which the determination of normal or abnormal is impossible.

3. The processing apparatus according to 2,

in which the registration unit stores the determination-impossible data in the storage unit in association with date and time when the determination-impossible data is detected.

4. The processing apparatus according to 2 or 3,

in which the registration unit stores the determination-impossible data in the storage unit in association with a machining condition of a product being processed by the target apparatus at the time when the determination-impossible data is detected.

5. The processing apparatus according to any one of 2 to 4,

in which the registration unit stores the determination-impossible data in the storage unit in association with an environment of the target apparatus at the time when the determination-impossible data is detected.

6. The processing apparatus according to any one of 2 to 5,

in which the registration unit stores the determination-impossible data in the storage unit in association with identification information of a product being processed by the target apparatus at the time when the determination-impossible data is detected.

7. The processing apparatus according to any one of 1 to 6, further including a control unit that controls an operation of the target apparatus.
8. The processing apparatus according to 7,

in which the control unit transmits a control signal for stopping the operation to the target apparatus in a case where determination is made that the target apparatus is abnormal on the basis of the detection data of the first sensor or the detection data of the second sensor.

9. The processing apparatus according to 7 or 8,

in which the control unit transmits a control signal for stopping the operation to the target apparatus in a case where the determination of normal or abnormal is impossible based on the detection data of the second sensor.

10. The processing apparatus according to any one of 1 to 9,

in which the first sensor and the second sensor detect vibration or sound, and

the second sensor has a bandwidth to be detected narrower than the first sensor.

11. The processing apparatus according to any one of 1 to 9,

in which the first sensor detects vibration or sound, and

the second sensor is a sensor that detects data other than vibration or sound.

12. The processing apparatus according to any one of 1 to 11,

in which the first sensor has power consumption smaller than the second sensor.

13. The processing apparatus according to any one of 1 to 12,

in which the target apparatus is a machining apparatus.

14. A processing method executed by a computer, the method including:

a first determination step of determining whether a target apparatus is normal or abnormal on the basis of detection data of a first sensor, and

a second determination step of, in a case where the determination of normal or abnormal is impossible based on the detection data of the first sensor, starting a second sensor and determining whether the target apparatus is normal or abnormal on the basis of detection data of the second sensor.

15. A program causing a computer to function as:

a first determination unit that determines whether a target apparatus is normal or abnormal on the basis of detection data of a first sensor, and

a second determination unit that, in a case where the determination of normal or abnormal is impossible based on the detection data of the first sensor, starts a second sensor and determines whether the target apparatus is normal or abnormal on the basis of detection data of the second sensor.

This application claims priority based on Japanese Patent Application No. 2017-103546 filed on May 25, 2017, the entire disclosure of which is incorporated herein by reference.

What is claimed is:

1. A processing apparatus comprising:
at least one memory configured to store one or more instructions; and
at least one processor configured to execute the one or more instructions to:
determine whether a target apparatus is normal or abnormal on the basis of detection data of a first sensor; and
in a case where the determination of normal or abnormal is impossible based on the detection data of the first sensor, start a second sensor and determine whether the target apparatus is normal or abnormal on the basis of detection data of the second sensor.

2. The processing apparatus according to claim 1,
wherein the processor is further configured to execute the one or more instructions to store, in a storage unit, determination-impossible data, which is the detection data of the first sensor and the detection data of the second sensor with which the determination of normal or abnormal is impossible.

3. The processing apparatus according to claim 2,
wherein the processor is further configured to execute the one or more instructions to store the determination-impossible data in the storage unit in association with date and time when the determination-impossible data is detected.

4. The processing apparatus according to claim 2,
wherein the processor is further configured to execute the one or more instructions to store the determination-impossible data in the storage unit in association with a machining condition of a product being processed by the target apparatus at the time when the determination-impossible data is detected.

5. The processing apparatus according to claim 2,
wherein the processor is further configured to execute the one or more instructions to store the determination-impossible data in the storage unit in association with an environment of the target apparatus at the time when the determination-impossible data is detected.

6. The processing apparatus according to claim 2,
wherein the processor is further configured to execute the one or more instructions to store the determination-impossible data in the storage unit in association with identification information of a product being processed by the target apparatus at the time when the determination-impossible data is detected.

7. The processing apparatus according to claim 1,
wherein the processor is further configured to execute the one or more instructions to control an operation of the target apparatus.

8. The processing apparatus according to claim 7,
wherein the processor is further configured to execute the one or more instructions to transmit a control signal for stopping the operation to the target apparatus in a case where determination is made that the target apparatus is abnormal on the basis of the detection data of the first sensor or the detection data of the second sensor.

9. The processing apparatus according to claim 7,
wherein the processor is further configured to execute the one or more instructions to transmit a control signal for stopping the operation to the target apparatus in a case where the determination of normal or abnormal is impossible based on the detection data of the second sensor.

10. The processing apparatus according to claim 1,
wherein the first sensor and the second sensor detect vibration or sound, and
the second sensor has a bandwidth to be detected narrower than the first sensor.

11. The processing apparatus according to claim 1,
wherein the first sensor detects vibration or sound, and
the second sensor is a sensor that detects data other than vibration or sound.

12. The processing apparatus according to claim 1,
wherein the first sensor has power consumption smaller than the second sensor.

13. The processing apparatus according to claim 1,
wherein the target apparatus is a machining apparatus.

14. A processing method executed by a computer, the method comprising:
determining whether a target apparatus is normal or abnormal on the basis of detection data of a first sensor; and
in a case where the determination of normal or abnormal is impossible based on the detection data of the first sensor, starting a second sensor and determining whether the target apparatus is normal or abnormal on the basis of detection data of the second sensor.

15. A non-transitory storage medium storing a program causing a computer to:
determine whether a target apparatus is normal or abnormal on the basis of detection data of a first sensor; and
in a case where the determination of normal or abnormal is impossible based on the detection data of the first sensor, start a second sensor and determine whether the target apparatus is normal or abnormal on the basis of detection data of the second sensor.
